(19) United States
(12) Patent Application Publication
(10) Pub. No.: US 2018/0141088 A1
(43) Pub. Date: May 24, 2018

(54) SERVICE TOOLS AND METHODS OF USING SAME

(71) Applicant: The Board of Trustees of The University of Alabama, Tuscaloosa, AL (US)

(72) Inventor: Teddy James Jackson, Northport, AL (US)

(21) Appl. No.: 15/817,477

(22) Filed: Nov. 20, 2017

Related U.S. Application Data
(60) Provisional application No. 62/425,685, filed on Nov. 23, 2016.

(51) Int. Cl. B08B 1/00

(52) U.S. Cl. CPC B08B 1/005; B08B 1/002

(57) ABSTRACT

The present application relates to service tools and methods for servicing an elevator.

### CROSS-REFERENCE TO RELATED APPLICATIONS

This application claims the benefit of U.S. Provisional Patent Application No. 62/425,685, filed Nov. 23, 2016, which is incorporated herein by reference in its entirety.

### TECHNICAL FIELD

The present application relates to a service tool and methods of using the service tool to service, for example, elevators and elevator components.

### BACKGROUND

During the operation of elevators, dust, dirt, and other debris can collect on the door rails, in the hoist way, in door sills, and in or on other components of an elevator, which can cause service issues for the elevator, including that the elevator may go out of service and require repair.

It is typical that an elevator operates in an elevator shaft, which is connected to a hoist way. The hoist way is a large vent in the building through which a large amount of air may pass. The air that passes through the hoist way and into the elevator shaft typically comes from the outside environment, which introduces dirt, dust, and debris into the elevator shaft. In addition, dust, dirt, and debris are introduced into the elevator shaft via the interior of a building that may be exposed or have access to the elevator shaft. The dirt, dust, and debris introduced to the elevator shaft may stick to the door rails on which the elevator doors slide or move to open and close.

It is typical that when an elevator comes to a stop, the elevator door or doors open (allowing passengers to board or disembark) and then close. Elevator doors are extremely heavy, sometimes weighing several hundred pounds. When the heavy elevator doors open, the opening of the door compresses or pushes the dirt, dust, or debris present on the door rail to an area of the door rail where the door is in a final opening position. When the elevator doors close, any dust, dirt, or debris likewise is pushed or compressed into a smaller area adjacent a final closed position of the elevator doors. Over a period of time, the compressed dirt, dust, or debris builds up and accumulates at the final opening and final closing positions, such that the elevator doors are prevented from traveling as far as is necessary for the elevator doors to fully open or close. As a result, the elevator is taken out of service until the door rails are cleaned.

Another common issue with elevators concerns unwanted trash or debris in the door sills of an elevator, which are the grooves that are on the threshold of an elevator car. Devices called gibs are mounted to the bottom of the elevator doors and travel in the door sills as the elevator doors close and open. The gibs typically fit tightly into each respective door sill or groove with little clearance. Accordingly, any foreign objects or materials in the door sills or grooves will cause the doors to bind and not completely open or close. As a result, the elevator will go out of service until proper maintenance and cleaning or clearing of the grooves is accomplished.

Very few options currently exist for servicing, cleaning, and maintaining various components of an elevator. For example, building maintenance workers, housekeeping personnel, or others responsible for upkeep of elevators may use sandpaper to remove dirt, dust, or other debris from the door rails or door sills of an elevator. With respect to sandpaper, many pieces of sandpaper are required to conduct any such maintenance or cleaning, in addition to those pieces of sandpaper being quickly worn and depleted. Further, a user of a piece of sandpaper cannot adequately and completely remove dust, dirt or other debris from components of an elevator.

The buildup of dirt, dust, or debris in or on various components of an elevator, including door rails or door sills, may cause the elevator to become inoperable, go out of service, and/or require maintenance. Service issues with elevators can cause passengers to get trapped inside and require assistance from, for example, fire and rescue or other emergency personnel. In addition, service calls are expensive and also require the elevator to be out of service for a period of time until repaired. Accordingly, there is a distinct need for a service tool for servicing elevators and elevator components.

### SUMMARY

Various implementation include service tools for servicing elevators and methods of using the service tool to service elevators. The details of various implementations are set forth in the accompanying drawings and the description below.

For example, a service tool according to various implementations includes an elongated rigid portion having a proximal end and a distal end. The elongated portion of the service tool is planar and defines a hook adjacent the distal end. The service tool further includes a scraper extending from the distal end of the service tool, and the scraper has a scraping edge that is spaced distally from the hook.

In some implementations, the service tool includes a longitudinal axis that extends through the proximal end and the distal end of the elongated portion. And, in some implementations, the scraping edge lies along a transverse axis that is orthogonal to the longitudinal axis. In some implementations, the elongated rigid portion includes an outer edge that extends between the proximal end and the distal end, and the outer edge defines the hook with the hook having a tip lying along the outer edge. The elongated rigid portion and scraper of the service tool are integrally formed from an elongated rigid plate, according to some implementations.

In some implementations, the hook has a diameter of 0.50 inches, and the scraping edge has a width between 0.25 inches and 0.50 inches, wherein the width is measured along a transverse axis that is orthogonal to a longitudinal axis extending between the proximal and distal ends of the elongated rigid portion.

In some implementations, the service tool includes an elongated handle having a proximal end and a distal end opposite the proximal end. The distal end of the elongated handle is coupled to the proximal end of the elongated rigid portion. In some implementations, the handle comprises at least one of wood, plastic, or metal. In some implementations, the service tool includes a brush coupled to the proximal end of the handle.

Various implementations also include a method for servicing an elevator. An exemplary method includes providing an elevator service tool and using the elevator service tool to service one or more components of the elevator. The elevator service tool has an elongated rigid portion that has a proximal end and a distal end. The elongated rigid portion of the elevator service tool defines a hook adjacent the distal end. The elevator service tool also includes a scraper extending from the distal end, and the scraper has a scraping edge that is spaced distally from the hook.

For example, in some implementations, one or more components of the elevator are serviced by using the hook to clean debris off of door rails of the elevator. In some implementations, one or more components of the elevator are serviced by using the scraper to clean debris out of door sills of the elevator. In some implementations, one or more components of the elevator are serviced by using the scraper to scrape debris away from one or more components of the elevator.

### DESCRIPTION OF DRAWINGS

In the drawings, like reference numbers and designations in the various drawings indicate like elements unless otherwise noted.

FIG. 1 illustrates an exemplary service tool according to one implementation.

FIG. 2 illustrates an elongated rigid portion of an exemplary service tool according to another implementation.

FIG. 3 illustrates the elongated rigid portion shown in FIG. 2 coupled with a handle.

FIG. 4 illustrates an exemplary service tool according to another implementation.

FIG. 5 illustrates an exemplary service tool according to another implementation.

FIG. 6 illustrates an exemplary service tool according to another implementation.

FIG. 7 illustrates an exemplary service tool according to another implementation.

FIG. 8 illustrates using the service tool shown in FIGS. 2 and 3 to remove debris off of door rails on an elevator.

FIG. 9 illustrates using the service tool shown in FIG. 1 to remove debris from door sills of an elevator.

### DETAILED DESCRIPTION

Various implementations are described hereinafter with reference to specific embodiments. Indeed, various implementations of the invention can be embodied in many different forms and should not be construed as limited to the embodiments set forth herein; rather, these embodiments are provided so that this disclosure will satisfy applicable legal requirements.

Referring to FIG. 1, an exemplary service tool 100 is shown. Service tool 100 can be used to clean, service, maintain, or repair an elevator's components. The service tool 100 includes a planar, elongated rigid portion 102 having a proximal end 104 and a distal end 106. A longitudinal axis 114 extends through the proximal 104 and the distal end 106 of the elongated rigid portion 102. Outer edges 117, 118 of the elongated rigid portion 102 extend between the proximal end 104 and the distal end 106 and are spaced apart from each other.

The outer edge 118 defines a hook 108 having a tip 120 that is adjacent the distal end 106 of the elongated rigid portion 102 and lies along the outer edge 118. The hook 108 includes a tip 120, an arcuate portion 132, and a straight slanted portion 130. The arcuate portion 132 extends between the tip 120 and the slanted portion 130, and the tip 120 is disposed distally of the slanted portion 130. The slanted portion 130 tapers toward the longitudinal axis 114 from the outer edge 118. In one implementation, the hook 108 has a diameter D of 0.50 inches. The hook 108 also may have a diameter of 0.1 inches, 0.2 inches, 0.3 inches, 0.4 inches, 0.5 inches, 0.6 inches, 0.7 inches, 0.8 inches, 0.9 inches, or 1 inch, or any other size that will sufficiently fit around an elevator door rail or other elevator components. In addition, the distal end 106 of the elongated rigid portion 102 has an arcuate shape extending between the edges 117, 118.

The service tool 100 further includes an elongated scraper 110 that extends from the distal end 106 of the elongated rigid portion 102. The scraper 110 includes a proximal end 111 and a distal end 113. The proximal end 111 of the scraper 110 is integrally formed with the distal end 106 of the elongated rigid portion 102, and the longitudinal axis 114 of the elongated rigid portion 102 extends through the proximal 111 and distal ends 113 of the scraper 110. In other implementations, the scraper 110 extends within a plane that includes the longitudinal axis 114 but does not extend along the longitudinal axis 114. For example, in some implementations, the scraper 110 extends from the distal end 106 but is offset from the longitudinal axis 114, and in other implementations, the scraper 110 extends from outer edge 117.

The proximal end 111 of the scraper 110 has a width W_{PS} that is less than a width W_{DE} of the distal end 106 and a width W_{DS} of the distal end 113 of the scraper 110. And, the width W_{DS} of the distal end 113 of the scraper 110 is less than the width W_{DE} of the distal end 106. Width is measured along a transverse axis 116 that is orthogonal to longitudinal axis 114 and intersects outer edges 117, 118. In addition, a distal portion 113a of the scraper 110 adjacent the distal end 113 is trapezoidal shaped, wherein the width of the distal portion 113a increases as it approaches the distal end 113.

The distal end 113 defines a scraping edge 112, which is spaced distally from the hook 108. The scraping edge 112 lies parallel to the transverse axis 116. The scraping edge 112 of the service tool 100 has a width W_{SC} between 0.25 inches and 0.50 inches. For example, the scraping edge 112 has a width W_{SC} that is 0.2 inches, 0.25 inches, 0.3 inches, 0.35 inches, 0.4 inches, 0.45 inches, 0.5 inches, or 0.55 inches, or any other size that will sufficiently allow for scraping or cleaning of components of an elevator.

The elongated rigid portion 102 and scraper 110 of the service tool 100 are integrally formed from an elongated rigid plate. The elongated rigid portion 102 and the elongated rigid plate may be formed out of any type of rigid material, including metal, plastic, steel, stone, synthetic material, or any other rigid material suitable for a service tool for servicing elevators and elevator components.

The service tool 100 also includes an elongated handle 122 having a proximal end 124 and a distal end 126 opposite the proximal end 124. The distal end 126 of the elongated handle 122 is coupled to the proximal end 104 of the elongated rigid portion 102. Longitudinal axis 114 extends through the proximal end 124 and the distal end 126 of the handle 122. The handle 122 comprises wood, plastic, and/or metal or other suitably rigid material. However, in other implementations, the handle 122 is offset from the longitudinal axis 114. And, in some implementations, the tool does not include an elongated handle.

The service tool 100 includes a brush 128 coupled to the proximal end 124 of the handle 122. The brush 128 is usable for cleaning or maintaining any component of an elevator. The bristles of brush 128 are comprised of any suitable material, including any natural material, synthetic material, animal hair, nylon, polyester, or a combination of nylon and polyester. However, in other implementations, the tool 100 does not include the brush 128. For example, tool 700 shown in FIG. 7 is similar to tool 100 but does not include the brush.

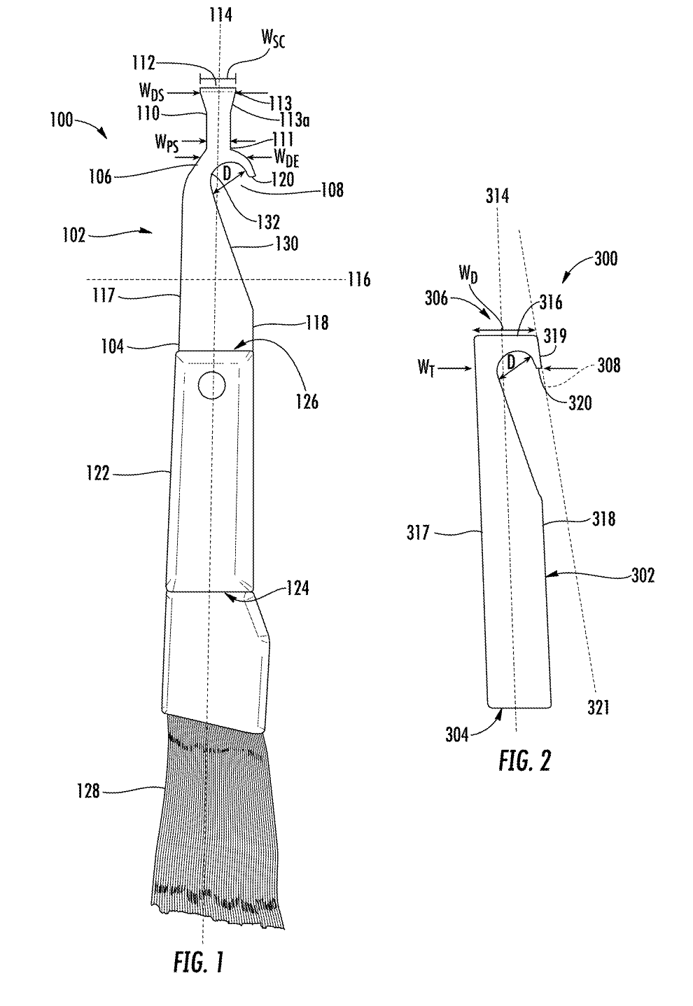

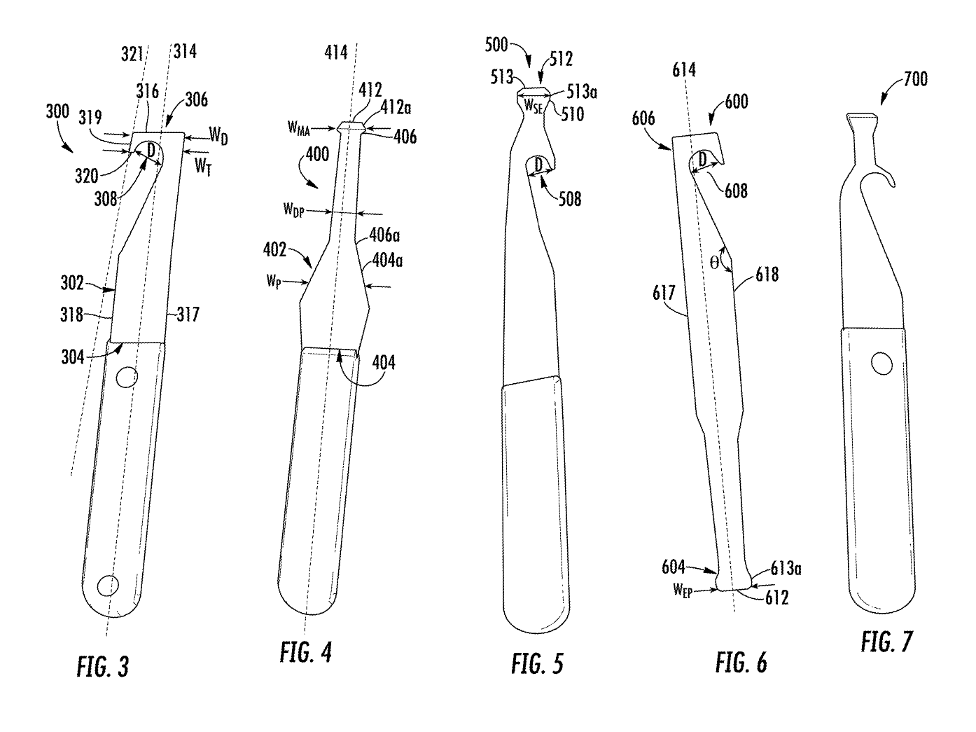

FIGS. 2 and 3 illustrate an exemplary service tool 300 according to another implementation. Similar to service tool 100, service tool 300 includes a planar, elongated rigid portion 302 that has a proximal end 304 and a distal end 306 and outer edges 317, 318 that extend between the proximal end 304 and the distal end 306 and are spaced apart from each other. Outer edge 318 defines a hook 308, wherein a tip 320 of the hook 308 lies along the outer edge 318 adjacent the distal end 306. Longitudinal axis 314 extends between the proximal end 304 and the distal end 306. However, unlike service tool 100, the distal end 306 of the service tool 300 is straight, and the tool 300 does not include a scraper extending from the distal end 306 of the tool 300. Instead, the straight distal end 306 defines a scraping edge 316 that extends along transverse axis 316, which is orthogonal to longitudinal axis 314 and intersects the outer edges 317, 318. In addition, a portion 319 of the outer edge 318 between the tip 320 of hook 308 and the distal end 306 lies along an axis 321 that is within the same plane but is not parallel to axis 314. A width W_{T} of the elongated rigid portion 302 through the tip 320 is greater than a width W_{D} of the elongated rigid portion 302 along the distal end 306.

FIG. 4 illustrates another implementation of a service tool 400. Service tool 400 is similar to the service tools 100, 300 described above, but service tool 400 does not define a hook along an outer edge of the elongated rigid portion 402 of the tool 400. In particular, the planar, elongated rigid portion 402 includes a proximal portion 404a adjacent a proximal end 404, a distal portion 406a adjacent a distal end 406, and a longitudinal axis 414 that extends between the proximal end 404 and the distal end 406. The proximal portion 404a has a width W_{P} that tapers inwardly toward the longitudinal axis 414 as the proximal portion 404a approaches the distal portion 406a. A width W_{DP} of the distal portion 406a adjacent the proximal portion 404a is less than a width W_{P} of the proximal portion 404a. Furthermore, the distal portion 406a defines a scraping portion 412a at the distal end 406, and the scraping portion 412a defines a scraping edge 412. The scraping portion 412a is elliptically shaped, and a width W_{MA} of a major axis of the scraping portion 412a is between 0.25 inches and 0.50 inches. In other implementations, the width W_{MA} is selected to allow the scraping portion 412a to scrape and clean components of an elevator.

FIG. 5 illustrates another implementation of a service tool 500. The service tool 500 is similar to the implementation in FIG. 1, but a scraper 510 of the tool 500 has an elliptically shaped distal portion 513a and a scraping edge 512 at a distal end 513 of the distal portion 513a. The hook 508 has a diameter D of 0.50 inches, or any other size that will sufficiently fit around an elevator door rail or other elevator components. A width W_{SE} of a major axis of the distal portion 513a of the service tool 500 is between 0.25 inches and 0.50 inches. However, in other implementations, the width W_{SE} of the major axis of the distal portion 513a of the service tool 500 is selected such that the scraping edge 512 is usable for scraping or cleaning of various components of an elevator.

FIG. 6 illustrates another implementation of a service tool 600 that is similar to the implementation in FIGS. 2 and 3 but does not include a handle. In addition, the tool 600 includes a hook end 606 and a scraper end 604. Outer edges 617, 618 extend between the hook end 606 and the scraper end 604. Outer edge 618 defines a hook 608 adjacent the hook end 606, and the hook end 606 is straight, as is described above in relation to FIGS. 2 and 3. The scraper end 604 is spaced apart from the hook end 606 along longitudinal axis 614 extending through the ends 604, 606 and defines an elliptically shaped portion 613a having a scraping edge 612 at the scraper end 604. The hook 608 has a diameter D of 0.50 inches. However in other implementations, the diameter D of the hook 608 is selected based on the width and depth of an elevator door rail or other elevator components. A width of a major axis of the elliptically shaped portion 613a has a width W_{EP} between 0.25 inches and 0.50 inches. However, in other implementations, the width W_{EP} is selected to allow for sufficient scraping or cleaning of components of an elevator.

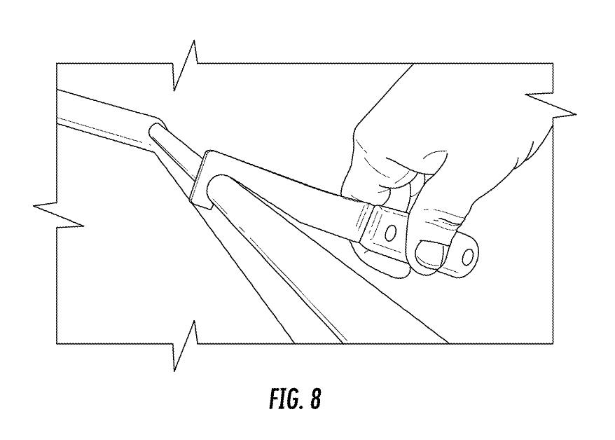

Also provided herein is a method for servicing an elevator. For example, in one implementation, the method includes providing an elevator service tool, such as the tools 100, 300, 400, 500, 600 described above, and using the tool to service one or more components of the elevator. For example, as shown in FIG. 8, the tip of the hook, such as hooks 108, 308, 508, 608, is inserted behind the door rail of the elevator and is pulled across the rail to clean debris off of the door rail and behind the door rail. The diameter of the hook is selected to correspond to the width of the rail to allow the hook to fit over the rail and pull debris off of the rail.

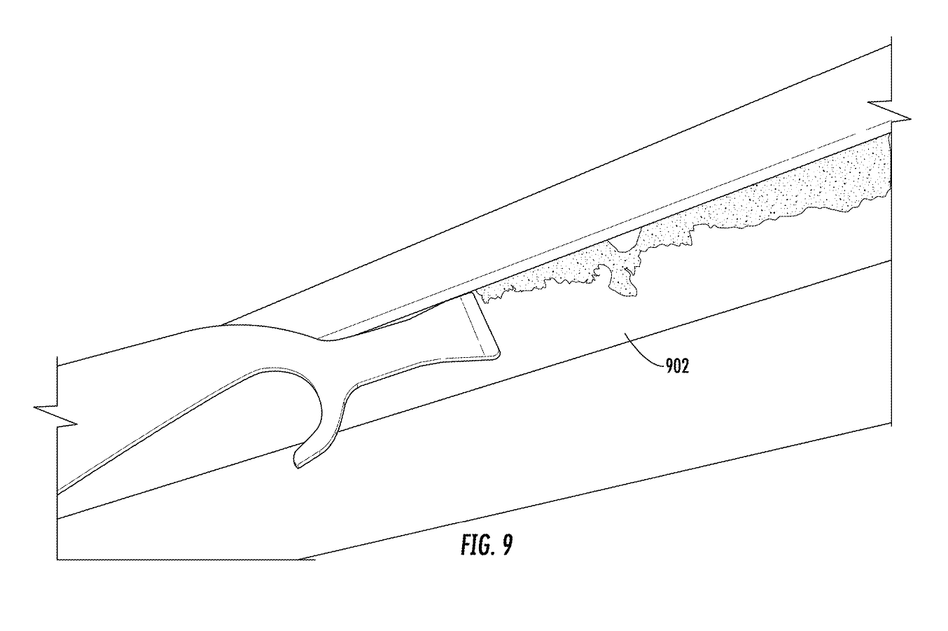

FIG. 9 shows another example of how the tool is usable to clean elevator components. In particular, a scraping edge of the tool, such as the scraping edges 112, 312, 412, 512, 612 described above, is pushed through a door sill 902 of the elevator to remove dirt, dust, or debris out of the door sill 902. The scraping edge is also usable to remove debris, dust, or dirt away from one or more other components of the elevator.

The terminology used herein is for the purpose of describing particular implementations only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The implementation was chosen and described in order to best explain the principles of the invention and the practical application, and to enable others of ordinary skill in the art to understand the invention for various implementations with various modifications as are suited to the particular use contemplated.

1. A service tool, comprising:
an elongated rigid portion having a proximal end and a distal end, wherein the elongated rigid portion is planar and defines a hook adjacent the distal end; and
a scraper extending from the distal end, the scraper having a scraping edge that is spaced distally from the hook.

2. The service tool of claim 1, wherein a longitudinal axis extends through the proximal end and the distal end of the elongated rigid portion, and the scraping edge lies along a transverse axis that is orthogonal to the longitudinal axis.

3. The service tool of claim 1, wherein the elongated rigid portion comprises an outer edge that extends between the proximal end and the distal end, and the outer edge defines the hook, the hook having a tip lying along the outer edge.

4. The service tool of claim 1, wherein the elongated rigid portion and scraper are integrally formed from an elongated rigid plate.

5. The service tool of claim 1, further comprising an elongated handle having a proximal end and a distal end opposite the proximal end, the distal end of the elongated handle being coupled to the proximal end of the elongated rigid portion.

6. The service tool of claim 5, wherein the handle comprises at least one of wood, plastic, or metal.

7. The service tool of claim 5, further comprising a brush coupled to the proximal end of the handle.

8. The service tool of claim 1, wherein the hook has a diameter of 0.50 inches.

9. The service tool of claim 1, wherein the scraping edge has a width between 0.25 inches and 0.50 inches, the width being measured along a transverse axis that is orthogonal to a longitudinal axis extending between the proximal and distal ends of the elongated rigid portion.

10. A method for servicing an elevator, comprising:
providing an elevator service tool, the elevator service tool having an elongated rigid portion having a proximal end and distal end, the elongated rigid portion defining a hook adjacent the distal end, the elevator service tool further comprising a scraper extending from the distal end, the scraper having a scraping edge that is spaced distally from the hook;
using the elevator service tool to service one or more components of the elevator.

11. The method of claim 10, wherein using the elevator service tool to service one or more components of the elevator comprises using the hook to clean debris off of door rails of the elevator.

12. The method of claim 10, wherein using the elevator service tool to service one or more components of the elevator comprises using the scraper to clean debris out of door sills of the elevator.

13. The method of claim 10, wherein using the elevator service tool to service one or more components of the elevator comprises using the scraper to scrape debris away from one or more components of the elevator.

14. The method of claim 10, wherein the hook has a diameter of 0.50 inches.

15. The method of claim 10, wherein the scraping edge has a width between 0.25 and 0.50 inches, the width being measured along a transverse axis that is orthogonal to a longitudinal axis extending between the proximal end and the distal end of the elongated rigid portion.

16. The method of claim 10, wherein the elevator service tool comprises an elongated handle coupled to the proximal end of the elongated rigid portion.
